(19) United States
(12) Patent Application Publication
(10) Pub. No.: US 2026/0342648 A1
(43) Pub. Date: Oct. 29, 2026

(54) METHODS AND APPARATUSES FOR RECEIVING AND SENDING CONFIGURATION INFORMATION, AND READABLE STORAGE MEDIUM

(71) Applicant: Beijing Xiaomi Mobile Software Co., Ltd., Beijing (CN)

(72) Inventor: Yi XIONG, Beijing (CN)

(73) Assignee: Beijing Xiaomi Mobile Software Co., Ltd., Beijing (CN)

(21) Appl. No.: 19/116,929

(22) PCT Filed: Sep. 29, 2022
(86) PCT No.: PCT/CN2022/122860

§ 371 Date: Mar. 28, 2025

(51) Int. Cl. H04L 41/0803

(52) U.S. Cl. CPC H04L 41/0803

(57) ABSTRACT

The present disclosure provides methods for receiving and sending configuration information. The method for receiving configuration information includes: receiving configuration information sent by a network device, the configuration information including at least one trigger condition for a conditional reconfiguration; and according to a movement parameter of a UE, determining a trigger condition corresponding to the triggering of the conditional reconfiguration.

### CROSS REFERENCE TO RELATED APPLICATIONS

The present disclosure is the U.S. national phase application of International Application No. PCT/CN2022/122860, filed on Sep. 29, 2022, the content of which is incorporated herein by reference in its entirety for all purposes.

### TECHNICAL FIELD

The present disclosure relates to the field of communication technology, in particular, to a method and an apparatus for receiving and sending configuration information, and a readable storage medium.

### BACKGROUND

In order to reduce interruption time for the handover of user equipment (UE), conditional reconfiguration is introduced in the 3rd Generation Partnership Project (3GPP) protocol. The UE releases the connection to the source cell after evaluating that a condition configured by the network device is met, and performs the handover to the target cell connection. The conditional reconfiguration includes conditional handover (CHO), conditional PSCell (primary secondary cell) change (CPC), and conditional PSCell addition (CPA).

In addition, it is proposed in 3GPP that the cellular network is used to provide services that meet the needs of unmanned aerial vehicles (UAV) in the enhanced support project for UAV. For example, the UAV UE can use wireless communication systems to achieve remote control and data transmission. The UAV UE has higher requirements for business continuity, and a flight state of the UAV UE will affect the channel environment. The configuration for the conditional reconfiguration of UE in the related art cannot be applied to such UAV UE.

### SUMMARY

In a first aspect, the present disclosure provides a method for receiving configuration information, which is performed by a user equipment (UE). The method includes:
receiving configuration information sent by a network device, wherein the configuration information includes at least one trigger condition for a conditional reconfiguration; and determining, based on a movement parameter of the UE, a trigger condition corresponding to triggering of the conditional reconfiguration.

In a second aspect, the present disclosure provides a method for receiving configuration information, which is performed by a user equipment (UE). The method includes:
receiving configuration information sent by a network device, wherein the configuration information includes a first type of trigger condition for a conditional reconfiguration, and the first type of trigger condition is related to a movement parameter of the UE.

In a third aspect, the present disclosure provides a method for sending configuration information, which is performed by a network device. The method includes:
sending configuration information to a user equipment (UE), wherein the configuration information includes at least one trigger condition for a conditional reconfiguration.

In a fourth aspect, the present disclosure provides a method for sending configuration information, which is performed by a network device. The method includes:
sending configuration information to a user equipment (UE), wherein the configuration information includes a first type of trigger condition for a conditional reconfiguration, and the first type of trigger condition is related to a movement parameter of the UE.

In a fifth aspect, the present disclosure provides a communication device including a processor and a memory.

The memory is configured to store a computer program.

The processor is configured to execute the computer program to implement the method as described in any of the first to the fourth aspects.

In a sixth aspect, the present disclosure provides a computer-readable storage medium having instructions stored thereon. When the instructions are called and executed on a computer, cause the computer to perform the method as described in any of the first to the fourth aspects.

In a seventh aspect, the present disclosure provides a communication system including a user equipment (UE) configured to perform the method as described in the first aspect and a network device configured to perform the method as described in the third aspect.

In an eighth aspect, the present disclosure provides a communication system including a user equipment (UE) configured to perform the method as described in the second aspect and a network device configured to perform the method as described in the fourth aspect.

### BRIEF DESCRIPTION OF THE DRAWINGS

The drawings described herein are used to provide further understanding of embodiments of the present disclosure and constitute a part of the present disclosure. The illustrative embodiments in the drawings and their explanations are used to explain the embodiments of the present disclosure and do not constitute undue limitations on the embodiments of the present disclosure.

The drawings are incorporated into and constitute a part of this specification, which illustrate embodiments consistent with the present disclosure, and serve together with the specification to explain the principles of the present disclosure.

FIG. 1 is a schematic diagram of an architecture of a wireless communication system according to one or more embodiments of the present disclosure.

FIG. 2 is a flowchart of a conditional handover (CHO) method.

FIG. 3 is a flowchart of a method for sending and receiving configuration information according to one or more embodiments of the present disclosure.

FIG. 4 is a flowchart of a method for sending and receiving configuration information according to one or more embodiments of the present disclosure.

FIG. 5 is a flowchart of a method for sending and receiving configuration information according to one or more embodiments of the present disclosure.

FIG. 6 is a schematic diagram of an apparatus for receiving configuration information according to one or more embodiments of the present disclosure.

FIG. 7 is a schematic diagram of an apparatus for sending configuration information according to one or more embodiments of the present disclosure.

### DETAILED DESCRIPTION

Further explanations of embodiments of the present disclosure will be provided in conjunction with the drawings and the detailed descriptions.

Detailed explanations of embodiments will be provided herein, which are illustrated in the drawings. The following description when referring to the drawings, unless otherwise indicated, the same reference numerals in different drawings represent the same or similar elements. The embodiments described in the following do not represent all embodiments consistent with the present disclosure. On the contrary, the embodiments are only examples of devices and methods consistent with some aspects of the present disclosure as detailed in the appended claims.

Terms used in present disclosure are for the purpose of describing specific embodiments only and are not intended to limit the present disclosure. Singular forms “a/an”, and “the” used in the present disclosure and the appended claims are also intended to include multiple forms, unless the context clearly indicates otherwise. It should also be understood that the term “and/or” used herein refers to and includes any or all possible combinations of one or more related items listed.

It should be understood that although various information may be described using terms such as first, second, third, etc. in the present disclosure, such information should not be limited to these terms. These terms are only used to distinguish information of the same type from each other. For example, without departing from the scope of the present disclosure, the first information can also be referred to as the second information, and similarly, the second information can also be referred to as the first information. For example, the word “if” and “provided” used herein can be interpreted as “when”, or “while”, or “in response to determination”, depending on the context.

Embodiments of the present disclosure will be described in the following in detail, examples of which are shown in the drawings, where the same or similar reference numerals indicate the same or similar elements throughout. The embodiments described below with reference to the drawings are exemplary and intended to explain the present disclosure, and should not be construed as limiting the present disclosure.

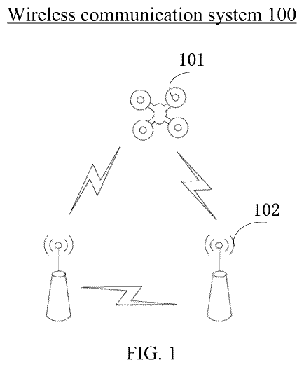

As shown in FIG. 1, a method for receiving and sending configuration information provided by embodiments of the present disclosure can be applied to a wireless communication system 100. The wireless communication system 100 can include an unmanned aerial vehicle user equipment (UAV UE) 101 and a network device 102. In some embodiments, the user equipment 101 is configured to support carrier aggregation and can be connected to multiple component carriers of the network device 102, including a primary component carrier and one or more secondary component carriers. The number of structures in the drawings is for illustration purposes only. For example, the wireless communication system 100 can include multiple UAV UEs 101, as well as other ground UEs.

It should be understood that the wireless communication system 100 can be applied to both low-frequency and high-frequency scenarios. The application scenarios of the wireless communication system 100 include but are not limited to Long Term Evolution (LTE) systems, LTE Frequency Division Duplex (FDD) systems, LTE Time Division Duplex (TDD) systems, Worldwide Interoperability for Microwave Access (WiMAX) communication systems, Cloud Radio Access Network (CRAN) systems, future 5th Generation (5G) systems, New Radio (NR) communication systems, or future evolved Public Land Mobile Network (PLMN) systems, etc.

The UAV UE 101 can be configured with a processing and communication structure, to allow the UAV UE 101 to receive location information through the wireless communication system 100, for navigation, as well as for the flight direction and trajectory control.

The network device 102 can be an access network device (or an access point). In some embodiments, the access network device refers to the device that can provide the network access function, for example, a radio access network (RAN) base station, etc. The network device 102 can include, for example, a base station (BS), or include a base station and a wireless resource management device for controlling the base station. The network device 102 can also include a relay station (a relay device), an access point, and base stations in future 5G networks, base stations in future evolved PLMN networks, or NR base stations, etc. The network device 102 can be a wearable device or an on-board device. The network device 102 can also be a communication chip with a communication module.

In some embodiments, the network device 102 includes but is not limited to next-generation base stations in 5G (gnodeB, gNB), evolved nodes in LTE systems (evolved node B, eNB), radio network controllers (RNC), nodes in WCDMA systems (node B, NB), wireless controllers and base station controllers (BSC) in CRAN systems, base transceiver stations (BTS) in GSM or CDMA systems, home base stations (e.g., home evolved node B, or home node B, HNB), baseband units (BBU), transmitting and receiving points (TRP), transmitting points (TP), or mobile switching centers, etc.

The ground UE is almost unaffected by altitude, while changes in the flight altitude of the UAV UE 101 have a significant impact on the channel environment of the UE.

A measurement reporting event based on an altitude and altitude reporting have been introduced in the LTE UAV. For example, for Event H1, an altitude of UE in the air is greater than a threshold, or for Event H2, an altitude of UE in the air is less than a threshold. In NR, the UAV UE 101 has requirements for lower latency and higher transmission rate, and thus the NR UAV needs to be enhanced on the basis of the LTE UAV.

In addition to the altitude variation, the UAV UE 101 also has a movement speed much higher than that of the ground UE, compared to the ground UE. The movement parameters such as the speed and the altitude of the UAV UE 101 will cause rapid changes in interference to which the UAV UE 101 is subjected, resulting in increase in handover frequency, radio link failure (RLF) rate, and out of synchronization rate (Qout proportion), which will seriously affect the performance and the business continuity of the UAV UE 101. Therefore, in order to improve the mobility reliability of the UAV UE 101, it is necessary to pay consideration to the influence of movement parameters such as the speed and the altitude on the conditional reconfiguration (CHO, CPA, or CPC).

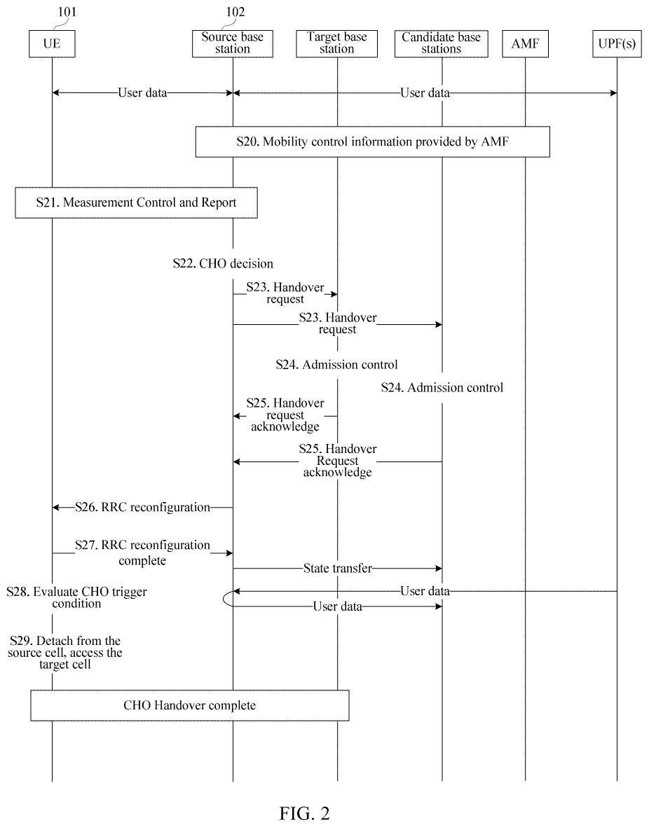

Before describing embodiments of the present disclosure, a CHO process in the relevant technology will be briefly described with reference to FIG. 2. FIG. 2 is a flowchart of a CHO method, which includes the following steps, S20-S29.
S20. The Access and Mobility Management Function (AMF) sends mobility control information.
S21. On the basis of the measurement configuration by the source base station 102, the user equipment 101 performs the movement measurement and reporting.
S22. The source base station 102 makes CHO decisions.
S23. The source base station 102 sends handover requests to multiple candidate base stations, the multiple candidate base stations including a target base station.
S24. The candidate base station performs admission control.
S25. The candidate base station sends a handover request response to the source base station 102.
S26. The source base station 102 sends an RRC reconfiguration message to the user equipment 101.
S27. The user equipment 101 replies that the reconfiguration is complete.
S28. The user equipment 101 evaluates a trigger condition for CHO and executes a step S29 when the trigger condition is met.
S29. The user equipment 101 detaches from the source cell and accesses the target cell.

The CHO handover will be completed after the steps. During the above process, the User Plane Function (UPF) is responsible for processing user data. From the moment the UE starts synchronizing with the target cell, the UE no longer monitors the source cell.

On the basis of this process, embodiments of the present disclosure involve mainly two aspects, namely during an applied process for the UAV UE, how to determines a trigger condition, and how to perform configuration adapt for the conditional reconfiguration of the UAV, which will be described in detail in the following embodiments of the present disclosure.

Embodiments of the present disclosure provide a method for receiving and sending configuration information. The method can be applied in scenarios where the movement parameters of the UAV UE 101 are variable. The method of the present disclosure intends to describe how to determine a trigger condition for the conditional reconfiguration in such scenarios.

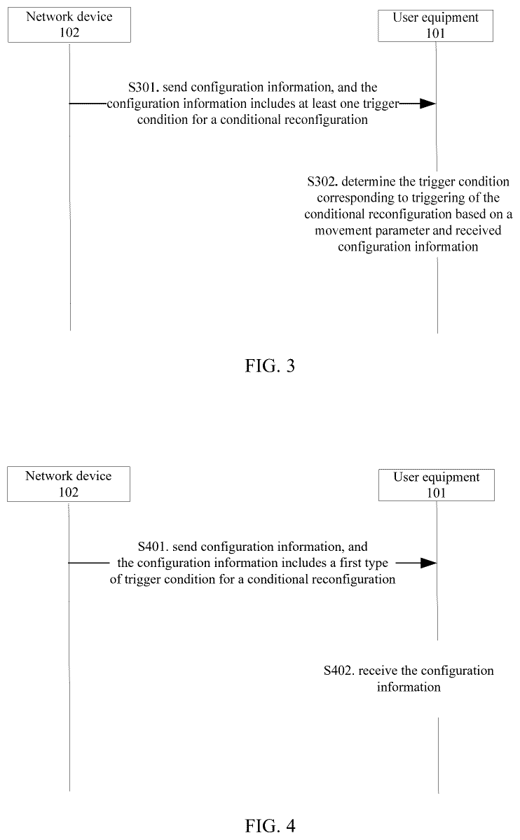

FIG. 3 is a flowchart of a method for receiving and sending configuration information according to one or more embodiments. As shown in FIG. 3, the method includes steps S301 and S302 detailed in the following.

In step S301, a network device 102 sends configuration information to a user equipment 101. The configuration information includes at least one trigger condition for a conditional reconfiguration.

In some embodiments, the user equipment 101 refers to the UAV UE 101, which can be abbreviated as the user equipment 101 in embodiments of the present disclosure.

In some embodiments, the network device 102 sends the configuration information through Radio Resource Control (RRC) signaling.

In some embodiments, the conditional reconfiguration includes CHO, CPA, or CPC, and the network device 101 can configure the trigger condition corresponding to each conditional reconfiguration.

For ease of description, the conditional reconfiguration CHO is taken as an example in the present disclosure.

In some embodiments, the trigger condition for configuring the CHO in the configuration information includes: a condition Event A3 (CondEvent A3), and/or a condition Event A5 (CondEvent A5). For example, the trigger condition configured in the configuration information includes an event A3. Alternatively, the trigger condition configured in the configuration information includes an Event A5. Alternatively, the trigger condition configured in the configuration information includes Event A3 and Event A5.

In some embodiments, in CondEvent A3, when an offset of a candidate cell is greater than an offset of a primary cell (PCell) or an offset of a primary secondary cell (PSCell), the conditional reconfiguration is performed to switch to the candidate cell.

In some embodiments, in CondEvent A5, when a signal strength in a PCell or PSCell is less than an absolute threshold 1 and a signal strength in a candidate cell is greater than an absolute threshold 2, the conditional reconfiguration is performed to switch to the candidate cell.

In step S302, the user equipment 101 determines the trigger condition corresponding to triggering of the conditional reconfiguration based on a movement parameter and received configuration information.

In some embodiments, the movement parameter includes but is not limited to a flight speed (referred to as speed) and/or a flight altitude (referred to as altitude) of the user equipment 101.

In some embodiments, the speed can be a vertical speed or a horizontal speed of the user equipment 101, and the altitude can be an altitude difference between the user equipment 101 and a horizontal plane, or an altitude difference between the user equipment 101 and a reference altitude.

In some embodiments, the user equipment 101 can obtain the movement speed based on a speed sensor of the user equipment itself. In some embodiments, the user equipment 101 determines the movement speed based on communication with the network device 102 at different times.

In some embodiments, the user equipment 101 can determine its location information based on the sensor of the user equipment itself, as well as the network device 102, a location server, etc. The speed or the altitude of the user equipment are determined based on the location information at different times.

In some embodiments, based on a current movement parameter of the user equipment 101, different trigger conditions may be adopted. That is, different trigger conditions are evaluated to determine whether to the perform conditional reconfiguration. When an adopted trigger condition is met, the conditional reconfiguration will be performed, and when the adopted trigger condition is not met, the conditional reconfiguration will not be performed.

In some embodiments, the configuration information can further include configuration information of a candidate cell.

In some embodiments, one candidate cell is configured in the configuration information, and the user equipment 101 evaluates whether the candidate cell meets the trigger condition. After the trigger condition is met and the conditional reconfiguration is triggered, the user equipment 101 can utilize the configuration information of the candidate cell. That is, the user equipment 101 can access the candidate cell corresponding to the configuration information, and detach from the source cell corresponding to network device 102.

In some embodiments, multiple candidate cells can be configured in the configuration information, and the user equipment 101 evaluates whether each candidate cell meets the trigger condition. The candidate cell that meets the trigger condition is the target cell. After the conditional reconfiguration is performed, the user equipment 101 can access the target cell.

In some embodiments, if the user equipment 101 receives a handover (HO) command before any trigger condition is met, then the user equipment 101 will perform the handover (legacy HO) process, ignoring the configuration information related to the conditional reconfiguration received before the command.

In some embodiments, the user equipment 101 determines the trigger condition corresponding to triggering of the conditional reconfiguration after receiving the configuration information, then starts to evaluate the trigger condition, and stops evaluating the trigger condition after the handover is performed.

In some embodiments, the step 302, where the user equipment 101 determines the trigger condition corresponding to triggering of the conditional reconfiguration based on the movement parameter, can include the following step S302-1 (not shown).

In step S302-1, based on whether the movement parameter of the user equipment 101 fulfills a demand, the user equipment 101 determines the trigger condition corresponding to triggering of the conditional reconfiguration.

In some embodiments, that the movement parameter of the user equipment 101 fulfills the demand can be one of the following:
the movement parameter is greater than a corresponding threshold; the movement parameter fulfills a corresponding event.

In some embodiments, the user equipment 101 determines whether the demand is fulfilled based on a relationship between the movement parameter and the corresponding threshold. To distinguish from the demands in some other embodiments, the demand herein is referred to as a first demand.

In some embodiments, the threshold corresponding to the movement parameter is defined in the protocol, or the threshold corresponding to the movement parameter is included in the configuration information. In some embodiments, a threshold corresponding to the speed and/or a threshold corresponding to the altitude are/is defined in the protocol. In some embodiments, the network device 102 also configures the threshold corresponding to the speed and/or the threshold corresponding to the altitude in the configuration information it sends.

In some embodiments, in the case where the movement parameter is the speed, and the configuration information includes a speed threshold corresponding to the speed. When the speed of the user equipment 101 is greater than the speed threshold, it is determined that the movement parameter fulfills the first demand. Alternatively, when the speed of the user equipment 101 is less than the speed threshold, it is determined that the movement parameter fulfills the first demand.

In some embodiments, in the case where the movement parameter is the altitude, and the configuration information includes an altitude threshold corresponding to the altitude. When the altitude of the user equipment 101 is greater than the altitude threshold, it is determined that the movement parameter fulfills the first demand. Alternatively, when the altitude of the user equipment 101 is less than the altitude threshold, it is determined that the movement parameter fulfills the first demand.

In some embodiments, the user equipment 101 determines whether the first demand is fulfilled based on whether the movement parameter fulfills the corresponding event.

In some embodiments, the event corresponding to the movement parameter is defined in the protocol, or the event corresponding to the movement parameter is included in the configuration information. In some embodiments, at least one event corresponding to the speed and/or at least one event corresponding to the altitude are/is defined in the protocol. In some embodiments, the network device 102 also configures the at least one event corresponding to the speed and/or the at least one event corresponding to the altitude in the configuration information it sends.

In some embodiments, in the case where the movement parameter is the speed, at least one of the following events is configured in the configuration information:
Event S1: the speed is greater than the first speed threshold S1; Event S2: the speed is less than the second speed threshold S2; Event S3: a change in the speed during a second time period is greater than the third speed threshold S3.

In some embodiments, when the speed of the user equipment 101 fulfills any one of the above events, it is determined that the movement parameter fulfills the first demand. Otherwise, it is determined that the movement parameter does not fulfill the first demand.

In some embodiments, in the case where the movement parameter is the altitude, at least one of the following events is configured in the configuration information:
Event H1: the altitude is greater than the first altitude threshold H1; Event H2: the altitude is less than the second altitude threshold H2; Event H3: a change in the altitude during a second time period is greater than the third altitude threshold H3.

In some embodiments, when the altitude of the user equipment 101 fulfills any one of the above events, it is determined that the movement parameter fulfills the first demand. Otherwise, it is determined that the movement parameter does not fulfill the first demand.

In some embodiments, in the case where the movement parameters are the speed and the altitude, events S1 to S3 and events H1 to H3 can be configured simultaneously in the configuration information, and the speed and the altitude will be judged separately. When the speed fulfills any one of Events S1 to S3 and/or the altitude fulfills any one of Events H1 to H3, the user equipment 101 determines that the movement parameter fulfills the first demand. Otherwise, the user equipment 101 determines that the movement parameter does not fulfill the first demand.

In some embodiments, the configuration information can also configure a hysteresis value and a trigger time corresponding to the movement parameter, and determine whether the movement parameter fulfills the first demand in combination with the hysteresis value and the trigger time.

In the above embodiments, where the threshold or the event corresponding to the movement parameter is configured in the configuration information is shown. In some other embodiments, the threshold or the event corresponding to the movement parameter can also be specified through the protocol definition.

In some embodiments, the user equipment 101 can also receive additional indication information sent by the network device 102, which is used to indicate that the user equipment 101 is allowed to determine the trigger condition or the parameter for triggering based on the movement parameter.

In some embodiments, the network device 102 does not send the indication information separately. According to the aforementioned embodiments, the network device 102 configures the threshold or the corresponding event for the movement parameter, which means that the network device 102 has indicated to the user equipment 101 that the user equipment 101 is allowed to determine the trigger condition or the parameter for triggering based on the movement parameter.

In some embodiments, the step S302-1 can include the following steps S302-1-11 (not shown) or S302-1-12 (not shown).

In step S302-1-11, in the case that the movement parameter fulfills the first demand, the user equipment 101 determines that the trigger condition corresponding to triggering of the conditional reconfiguration is the first condition of the at least one trigger condition.

In step S302-1-12, in the case that the movement parameter does not fulfill the first demand, the user equipment 101 determines that the trigger condition corresponding to triggering of the conditional reconfiguration is the second condition of the at least one trigger condition.

In some embodiments, the first condition or the second condition can be defined in the protocol or configured by the network device 102.

In some embodiments, for different types of the conditional reconfigurations, the first conditions defined by the protocol or configured by the network may differ. For example, the first condition corresponding to CHO is different from the first condition corresponding to CPC.

In some embodiments, the conditional reconfiguration CHO is taken as an example, the first condition defined by the protocol or configured by the network is A3 or A5.

In some embodiments, the trigger condition configured for CHO in the configuration information includes the first condition A3 and the second condition A5.

In some embodiments, if the user equipment 101 determines that the movement parameter fulfills the first demand, then it determines to adopt the first condition A3. That is, the user equipment 101 evaluates the first condition A3 to determine whether to perform CHO. If the user equipment 101 determines that the movement parameter does not fulfill the first demand, then it determines to adopt the second condition A5. That is, the user equipment 101 evaluates the second condition A5 to determine whether to perform CHO.

Based on the aforementioned embodiments, when the movement parameter is greater than or less than the corresponding threshold, or the movement parameter fulfills the corresponding event, then the movement parameter fulfills the first demand.

For example, the first demand is fulfilled when at least one of the following conditions is met: the speed is greater than the corresponding speed threshold, the speed fulfills any one of the events S1 to S3, the altitude is greater than the corresponding altitude threshold, or the altitude fulfills any one of the events H1 to H3. If none of the above conditions is met, the movement parameter does not fulfill the first demand.

In some embodiments, the step S302-1 can include the following steps S302-1-21 (not shown) to S302-1-22 (not shown).

In step S302-1-21, based on whether the movement parameter of the user equipment 101 fulfills the first demand, the user equipment 101 determines the parameter for triggering to be adopted.

In step S302-1-22, the user equipment 101 determines the trigger condition corresponding to triggering of the conditional reconfiguration based on the parameter for triggering to be adopted.

In some embodiments, the parameter for triggering corresponding to the trigger condition is defined in the protocol.

In some embodiments, the configuration information sent by the network device 102 further includes at least one parameter for triggering corresponding to each trigger condition of the at least one trigger condition.

In some embodiments, for different trigger conditions, the parameters for triggering corresponding to the trigger conditions defined by the network device 102 or in the protocol may vary. The trigger condition being Event A3 or Event A5 is taken as an example for explanation. When the trigger condition is Event A3, the parameter for triggering corresponding to A3 includes an offset, and when the trigger condition is Event A5, the parameter for triggering corresponding to A5 includes an absolute threshold 1 and an absolute threshold 2.

In some embodiments, the parameter for triggering corresponding to Event A3 defined in the protocol or configured by the network device 102 is an offset1.

In some embodiments, the parameter for triggering corresponding to Event A3 defined in the protocol or configured by the network device 102 includes an offset1 and an offset2.

In some embodiments, in combination with the judgment described in aforementioned embodiments, if the user equipment 101 determines that the movement parameter (speed and/or altitude) fulfills the first demand, it then determines to adopt the first parameter for triggering, and triggers the conditional reconfiguration based on the trigger condition corresponding to the first parameter for triggering. In the case where the first demand is not fulfilled, the user equipment 101 determines the trigger condition corresponding to the second parameter for triggering to trigger the conditional reconfiguration.

In some embodiments, the first parameter for triggering is defined in the protocol or configured by the network device 102.

In some embodiments, the parameter for triggering corresponding to Event A3 includes an offset1 and an offset2, with the first parameter for triggering being the offset1, and the second parameter for triggering being the offset2.

In some embodiments, in the case that the user equipment 101 determines that the movement parameter fulfills the first demand, the user equipment 101 will perform evaluation based on Event A3 corresponding to the first parameter for triggering, that is, the user equipment 101 evaluates whether the offset of the candidate cell is greater than the first parameter for triggering offset1. If the offset of the candidate cell is greater than the first parameter for triggering offset1, the conditional handover can be performed. In the case where the movement parameter does not fulfill the first demand, the user equipment 101 will perform evaluation based on Event A3 corresponding to the second parameter for triggering, that is, the user equipment 101 evaluates whether the offset of the candidate cell is greater than the first parameter for triggering offset 2.

In some embodiments, the parameter for triggering corresponding to Event A3 is an offset1, and the parameter for triggering corresponding to Event A5 is an absolute threshold 1 and an absolute threshold 2. In some embodiments, the first parameter for triggering is the offset1, and the second parameter for triggering is the absolute threshold 1 or the absolute threshold 2.

In some embodiments, in the case that the user equipment 101 determines that the movement parameter fulfills the first demand, the user equipment 101 will perform evaluation based on Event A3 corresponding to the first parameter for triggering, that is, the user equipment 101 evaluates whether the offset of the candidate cell is greater than the first parameter for triggering offset1. If the offset of the candidate cell is greater than the first parameter for triggering offset1, the conditional handover can be performed. In the case where the movement parameter does not fulfill the first demand, the user equipment 101 will perform evaluation based on Event A5 corresponding to the second parameter for triggering.

Based on the above embodiments, in the present disclosure, different parameters for triggering or different trigger conditions may be selected for different speeds and/or altitudes, so as to better adapt to the UAV UE 101 with variable movement parameters and improve the reliability of the conditional reconfiguration.

In some embodiments, in addition to configuring the parameter for triggering, a hysteresis value and a trigger time corresponding to the trigger condition can also be configured.

In some embodiments, the step S302-1 can include the following steps S302-1-31 (not shown) and S302-1-32 (not shown).

In step S302-1-31, in the case that the movement parameter fulfills the first demand, the user equipment 101 determines the parameter for triggering to be adopted based on a parameter adjustment value and a reference parameter for triggering.

In step S302-1-32, the user equipment 101 determines the trigger condition corresponding to triggering of the conditional reconfiguration based on the parameter for triggering to be adopted.

In some embodiments, the step S302-1 can include the following steps S302-1-31′ (not shown) and S302-1-32.

In step S302-1-31′, in the case that the movement parameter does not fulfill the first demand, the user equipment 101 determines a reference parameter for triggering as the parameter for triggering to be adopted.

In some embodiments, the configuration information further includes a reference parameter for triggering and a parameter adjustment value.

In some embodiments, in the configuration information, if only one parameter for triggering is configured for each trigger condition, the configured parameter for triggering is the reference parameter for triggering for that trigger condition.

In some embodiments, in the configuration information, if more than one parameter for triggering is configured for each trigger condition, one of the parameters for triggering can be specified as the reference parameter for triggering for that trigger condition.

In some embodiments, the reference parameter for triggering can be a parameter for triggering defined in the relevant protocol. For example, when the trigger condition is Event A3, the reference parameter for triggering can be an offset corresponding to A3 in the relevant protocol.

In some embodiments, each reference parameter for triggering corresponds to a parameter adjustment value.

In some embodiments, in combination with the judgment described in aforementioned embodiments, the user equipment 101 can determine whether the movement parameter fulfills the first demand. For example, when the movement parameter is greater than the corresponding threshold or fulfills the corresponding event, the movement parameter fulfills the first demand.

In some embodiments, the parameter adjustment value can also be defined in the protocol.

In some embodiments, the way to adjust the reference parameter for triggering based on the parameter adjustment value can be defined in the protocol or configured by the network device 102.

In some examples, an adjusted parameter for triggering is determined based on a sum of the parameter adjustment value and the reference parameter for triggering.

In some examples, an adjusted parameter for triggering is determined based on a difference between the parameter adjustment value and the reference parameter for triggering.

In some examples, a scaling or expansion parameter for triggering is determined based on a product or a quotient of the parameter adjustment value and the reference parameter for triggering.

In some embodiments, when the movement parameter does not fulfill the first demand, the reference parameter for triggering is determined as the parameter for triggering to be adopted. That is, when the movement parameter does not fulfill the first demand, no adjustment is made to the reference parameter for triggering.

In some embodiments, the reference parameter for triggering corresponds to the first condition, and the adjusted parameter for triggering obtained based on the parameter adjustment value corresponds to the second condition.

In some embodiments, the step S302-1 can include the following step S302-1-41 (not shown).

In step S302-1-41, in the case that the moving parameter changes from fulfilling the demand to not fulfilling the demand during a first time period, it is determined that the trigger condition changes from a trigger condition corresponding to fulfilling the demand to a trigger condition corresponding to not fulfilling the demand.

In some embodiments, when the moving parameter changes from fulfilling the first demand to not fulfilling the first demand during the first time period, the trigger condition corresponding to triggering of the conditional reconfiguration switches from the first condition to the second condition.

In some embodiments, the first time period is included in a time period for evaluating the first condition.

In some embodiments, whether the first time period is reached can be determined by configuring a corresponding timer.

In some embodiments, in combination with the descriptions in aforementioned embodiments, when the first demand is fulfilled, the user equipment 101 can determine that the trigger condition corresponding to triggering of the conditional reconfiguration is the first condition.

Then if the movement parameter changes due to the movement of the user equipment 101 during the first time period, and if the movement parameter no longer fulfills the first demand, the user equipment 101 will stop evaluating the first condition, the second condition will become the trigger condition, and the user equipment 101 will begin to evaluate the second condition. Similarly, in some embodiments, if the movement parameter changes from not fulfilling the first demand to fulfilling the first demand, the trigger condition corresponding to triggering of the conditional reconfiguration switches from the second condition to the first condition.

According to embodiments of the present disclosure, the UAV UE 101 determines, based on the movement parameter, the trigger condition to be adopted for performing the conditional reconfiguration, which can improve the influence of UAV movement parameters on the channel during the conditional reconfiguration process, thereby enhancing the reliability and rationality of the conditional reconfiguration.

To facilitate further understanding of how to determine the trigger condition for the conditional reconfiguration in embodiments of the present disclosure in scenarios where the UAV UE 101 has variable movement parameters, more specific cases will be listed in the following.

### Example One

The information that can be included in the configuration information issued by network device 102 is introduced in the example.

Based on the descriptions in aforementioned embodiments, the configuration information can include at least one trigger condition for the conditional reconfiguration. In addition, the configuration information can further include at least one of the following:
a parameter for triggering corresponding to the trigger condition; a first condition in the trigger condition; a threshold corresponding to a movement parameter; an event corresponding to a movement parameter; a parameter adjustment value; configuration information of a candidate cell.

### Example Two

How the user equipment 101 determines the trigger condition based on the movement parameter is introduced in the example.

The configuration information includes at least one trigger condition for the conditional reconfiguration, the threshold corresponding to the movement parameter or the event corresponding to the movement parameter (Events S1 to S3 and Events H1 to H3), and the configuration information of the candidate cell.

The user equipment 101 determines, based on the movement parameter (the speed and/or the altitude), whether the first demand is fulfilled. For example, when the movement parameter is greater than the corresponding threshold or fulfills the corresponding event, it is determined that the first demand is fulfilled and the first condition is determined as the trigger condition.

The first condition can be defined in the protocol or indicated through the configuration information synchronously.

### Example Three

The conditional reconfiguration or reselection of the trigger condition after the trigger condition is determined is introduced in the example.

In one aspect, on the basis of Example Two, the user equipment 101 can evaluate the first condition after determining the first condition as the trigger condition. For example, the first condition is Event A3. When an offset of the candidate cell is greater than an offset of the service cell, the conditional reconfiguration CHO will be triggered, and the user equipment 101 will be connected with the candidate cell.

In another aspect, on the basis of Example Two, if the movement parameter changes from fulfilling the first demand to not fulfilling the first demand during the first time period, the evaluation of the first condition will stop and the evaluation of the second condition will start. For example, if the second condition is Event A5, whether the candidate cell fulfills the second condition will be evaluated. When the second condition is met, the conditional reconfiguration CHO will be triggered, and the user equipment 101 will be connected with the candidate cell.

### Example Four

How the user equipment 101 determines the parameter for triggering based on the movement parameter, and thus determining the trigger condition is introduced in the example.

The configuration information includes at least one trigger condition for the conditional reconfiguration, the parameter for triggering, the threshold corresponding to the movement parameter or the event corresponding to the movement parameter (Events S1 to S3 and Events H1 to H3), and the configuration information of the candidate cell.

The user equipment 101 determines, based on the movement parameter (the speed and/or the altitude), whether the first demand is fulfilled. For example, when the movement parameter is greater than the corresponding threshold or the movement parameter fulfills the corresponding event, it is determined that the first demand is fulfilled, the first parameter for triggering is determined as the parameter for triggering, and the trigger condition corresponding to the first parameter for triggering is then determined.

After determining the trigger condition, the user equipment 101 evaluates the trigger condition to trigger the conditional reconfiguration.

During the first time period, when the movement parameter changes from fulfilling the first demand to not fulfilling the first demand, the corresponding parameter for triggering will change, and the evaluated trigger condition will also change, as described in Example Three.

### Example Five

The user equipment 101 determining, based on the movement parameter, whether to adjust the parameter for triggering, and thus determining the trigger condition is introduced in the example.

The configuration information includes at least one trigger condition for the conditional reconfiguration, the reference parameter for triggering, the parameter adjustment value, the threshold corresponding to the movement parameter or the event corresponding to the movement parameter (Events S1 to S3 and Events H1 to H3), and the configuration information of the candidate cell.

The user equipment 101 determines, based on the movement parameter (the speed and/or the altitude), whether the first demand is fulfilled. For example, when the movement parameter is greater than the corresponding threshold or the movement parameter fulfills the corresponding event, it is determined that the first demand is fulfilled. The user equipment 101 adjusts the reference parameter for triggering using the parameter adjustment value and uses the adjusted parameter for triggering to determine the trigger condition.

After determining the trigger condition, the user equipment 101 evaluates the trigger condition to trigger the conditional reconfiguration.

During the first time period, when the movement parameter changes from fulfilling the first demand to not fulfilling the first demand, whether the parameter for triggering needs to be adjusted will change correspondingly, and the corresponding evaluated trigger condition will change adaptively, as described in Example Three.

Embodiments of the present disclosure provide a method for receiving and sending configuration information. The method can be applied in scenarios where the movement parameters of the UAV UE 101 are variable. The method of the present disclosure intends to describe how to configure for the conditional reconfiguration in such scenarios.

FIG. 4 is a flowchart of a method for receiving and sending configuration information according to one or more embodiments. As shown in FIG. 4, the method includes steps S401 and S402 detailed in the following.

In step S401, a network device 102 sends configuration information to a user equipment 101. The configuration information includes a first type of trigger condition for a conditional reconfiguration, and the first type of trigger condition is related to a movement parameter of the user equipment 101.

In some embodiments, the user equipment 101 refers to the UAV UE 101, which can be abbreviated as the user equipment 101 in embodiments of the present disclosure.

In some embodiments, the movement parameter includes but is not limited to a speed and/or an altitude of the user equipment 101.

In some embodiments, the first type of trigger condition includes at least one of the following events:
the movement parameter is greater than a corresponding first threshold; the movement parameter is less than a corresponding second threshold; a change in the movement parameter during a second time period is greater than a corresponding third threshold.

In some embodiments, the movement parameter can be the speed or the altitude. Therefore, the first threshold includes a first speed threshold and a first altitude threshold, the second threshold includes a second speed threshold and a second altitude threshold, and the third threshold includes a third speed threshold and a third altitude threshold.

In some embodiments, in the case where the movement parameter is the speed, at least one of the following events is configured in the configuration information:
Event S1: the speed is greater than the first speed threshold S1; Event S2: the speed is less than the second speed threshold S2; Event S3: a change in the speed during a second time period is greater than the third speed threshold S3.

In some embodiments, in the case where the movement parameter is the altitude, at least one of the following events is configured in the configuration information:
Event H1: the altitude is greater than the first altitude threshold H1; Event H2: the altitude is less than the second altitude threshold H2; Event H3: a change in the altitude during a second time period is greater than the third altitude threshold H3.

In step S402, the user equipment 101 receives the configuration information.

According to embodiments of the present disclosure, the user equipment 101 obtains the first type of trigger condition through the configuration information sent by the network device 102. The first type of trigger condition is related to the movement parameter, and can be used to trigger the conditional reconfiguration, which can improve the influence of the movement of the user equipment with variable movement parameters on the channel, thereby enhancing the reliability and rationality of the conditional reconfiguration of the user equipment.

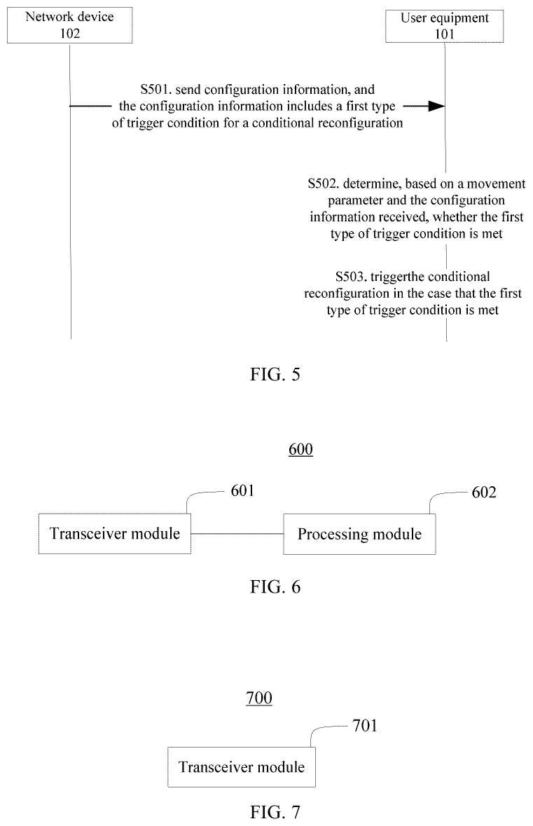

Embodiments of the present disclosure provide a method for receiving and sending configuration information. FIG. 5 is a flowchart of a method for receiving and sending configuration information according to one or more embodiments. As shown in FIG. 5, the method includes steps S501 to S503 detailed in the following.

In step S501, a network device 102 sends configuration information to a user equipment 101. The configuration information includes a first type of trigger condition for a conditional reconfiguration, and the first type of trigger condition is related to a movement parameter of the user equipment 101.

In step S502, the user equipment 101 determines, based on a movement parameter and the configuration information received, whether the first type of trigger condition is met.

In some embodiments, the movement parameter includes but is not limited to a speed and/or an altitude of the user equipment 101.

In some embodiments, the first type of trigger condition includes at least one of the following events:
the movement parameter is greater than a corresponding first threshold; the movement parameter is less than a corresponding second threshold; a change in the movement parameter during a second time period is greater than a corresponding third threshold.

When any one of the above events is fulfilled, the first type of trigger condition is met.

In some embodiments, in the case where the movement parameter is the speed, at least one of the following events is configured in the configuration information:
Event S1: the speed is greater than the first speed threshold S1; Event S2: the speed is less than the second speed threshold S2; Event S3: a change in the speed during a second time period is greater than the third speed threshold S3.

When the speed fulfills any one of the above events, the user equipment 101 determines that the first type of trigger condition is met. If the speed fulfills none of the above events, the user equipment 101 determines that the first type of trigger condition is not met.

In some embodiments, in the case where the movement parameter is the altitude, at least one of the following events is configured in the configuration information:
Event H1: the altitude is greater than the first altitude threshold H1; Event H2: the altitude is less than the second altitude threshold H2; Event H3: a change in the altitude during a second time period is greater than the third altitude threshold H3.

When the altitude fulfills any one of the above events, the user equipment 101 determines that the first type of trigger condition is met. If the altitude fulfills none of the above events, the user equipment 101 determines that the first type of trigger condition is not met.

In other embodiments, when the movement parameter includes the speed and the altitude, the speed and the altitude will be judged separately. When the speed fulfills any one of Events S1 to S3 and/or the altitude fulfills any one of Events H1 to H3, the user equipment 101 determines that the first type of trigger condition is met.

In step S503, the conditional reconfiguration is triggered in the case that the first type of trigger condition is met.

In some embodiments, the conditional reconfiguration includes CHO, CPA, or CPC.

The CHO is taken as an example, the configuration information further includes the configuration of the candidate cell. When the user equipment 101 determines that the first type of trigger condition is met, the conditional reconfiguration will be triggered, and the configuration of the candidate cell will be applied, so as to switch to that candidate cell.

In some embodiments, the configuration information further includes a second type of trigger condition for the conditional reconfiguration. The second type of trigger condition is related to a signal strength in the cell.

In some embodiments, the second type of trigger condition can be configured as the event for the conditional triggering defined in the relevant protocol. For example, the CHO is taken as an example, the second type of trigger condition includes at least one of Event A3, Event A4, or Event A5.

In some embodiments, when the first type of trigger condition is configured, the second type of trigger condition must be configured simultaneously.

In some embodiments, the user equipment 101 determines, based on a combination of the first type of trigger condition and the second type of trigger condition, whether to trigger the conditional reconfiguration. For example, the conditional reconfiguration will be triggered when both the first type of trigger condition and the second type of trigger condition are met, so that the rationality of the conditional reconfiguration can be improved.

In some embodiments, when the configuration information includes the first type of trigger condition and the second type of trigger condition, the method can include the following steps S501-1 to S503-1 (not shown) detailed in the following.

In step S501-1, a network device 102 sends configuration information to a user equipment 101. The configuration information includes a first type of trigger condition and a second type of trigger condition for a conditional reconfiguration.

In step S502-1, the user equipment 101 determines, based on a movement parameter and the configuration information received, whether a second demand is fulfilled.

In some embodiments, fulfilling a demand includes: any one of events in the first type of trigger condition is met, and a second type of trigger condition corresponding to the any one of the events is fulfilled. For the purpose of distinguishing from the demand in aforementioned embodiments, the demand here is referred to as the second demand.

In some embodiments, when any one of the events in the first type of trigger condition is met, the second type of trigger condition corresponding to the any one of the events is either a first condition or a second condition.

In some embodiments, the first condition or the second condition can be defined in the protocol or configured by the network device 102.

In some embodiments, the conditional reconfiguration CHO is taken as an example, and the first condition can be A3.

In some embodiments, the first type of trigger condition includes at least one of the following events:
the movement parameter is greater than a corresponding first threshold; the movement parameter is less than a corresponding second threshold; a change in the movement parameter during a second time period is greater than a corresponding third threshold.

In some embodiments, in the case that the movement parameter fulfills any one of the above events, the corresponding second type of trigger condition is evaluated, for example, the first condition A3 is evaluated. When the first condition is met, that is, when the offset of the candidate cell is greater than the offset of the service cell, it is determined that the second demand is fulfilled.

In step S503-1, the conditional reconfiguration is triggered in the case that the second demand is fulfilled.

In some embodiments, when the second demand is fulfilled, based on the configuration of the candidate cell that fulfills the second demand, the user equipment is connected to the candidate cell and disconnected from the source cell.

Based on the same concept as the above method embodiments, embodiments of the present disclosure also provide a user equipment 101 for executing steps of the methods performed by the user equipment 101 in the above embodiments.

In some embodiments, the apparatus 600 shown in FIG. 6 can serve as the user equipment 101 involved in the above method embodiments and execute the steps of the methods performed by the user equipment 101 in the method embodiments.

The apparatus 600 includes a transceiver module 601 and a processing module 602.

The transceiver module 601 is configured to receive configuration information sent by a network device, with the configuration information including at least one trigger condition for a conditional reconfiguration.

The processing module 602 is configured to determine, based on a movement parameter of the user equipment, a trigger condition corresponding to triggering of the conditional reconfiguration.

In some embodiments, the transceiver module 601 is also configured to receive configuration information sent by a network device, with the configuration information including a first type of trigger condition for a conditional reconfiguration, and the first type of trigger condition being related to a movement parameter of the user equipment.

Embodiments of the present disclosure also provide a communication device including a processor and a memory.

The memory is configured to store a computer program.

The processor is configured to execute the computer program to implement the methods performed by the user equipment 101.

Embodiments of the present disclosure also provide a non-transitory computer-readable storage medium, which stores instructions. When the instructions are called and executed on a computer, cause the computer to implement the methods performed by the user equipment 101.

Based on the same concept as the method embodiments, embodiments of the present disclosure also provide a network device 102 for executing steps of the methods performed by the network device 102 in the embodiments.

In some embodiments, the apparatus 700 shown in FIG. 7 can serve as the network device 102 involved in the above method embodiments and execute the steps of the methods performed by the network device 102 in the method embodiments.

The apparatus 700 includes a transceiver module 701.

The transceiver module 701 is configured to send configuration information to a user equipment, with the configuration information including at least one trigger condition for a conditional reconfiguration.

In some embodiments, the transceiver module 701 is also configured to send configuration information to a user equipment, with the configuration information including a first type of trigger condition for a conditional reconfiguration, and the first type of trigger condition being related to a movement parameter of the user equipment.

Embodiments of the present disclosure also provide a communication device including a processor and a memory.

The memory is configured to store a computer program.

The processor is configured to execute the computer program to implement the methods performed the network device 102.

Embodiments of the present disclosure also provide a non-transitory computer-readable storage medium, which stores instructions. When the instructions are called and executed on a computer, cause the computer to implement the methods performed by the network device 102.

After considering the specification and practices of the invention disclosed herein, those skilled in the art will easily come up with other implementation solutions of the present disclosure. The present disclosure aims to cover any variations, uses, or adaptive changes of the present disclosure, which follow the general principles of the present disclosure and include common knowledge or commonly used technical means in the art that are not disclosed in the present disclosure. The specification and embodiments are only considered exemplary, and the true scope and spirit of the present disclosure are defined by appended claims.

It should be understood that the present disclosure is not limited to the precise structure described above and shown in the drawings, and various modifications and changes can be made without departing from its scope. The scope of the present disclosure is limited only by the appended claims.

### Industrial Applicability

In embodiments of the present disclosure, the user equipment determines, based on the movement parameter, the trigger condition corresponding to triggering of the conditional reconfiguration. In the conditional reconfiguration process, the influence of the movement of the user equipment with variable movement parameters on the channel is improved, and the reliability and rationality of the conditional reconfiguration of the user equipment is enhanced.

1. A method for receiving configuration information, performed by a user equipment (UE), the method comprising:
receiving configuration information sent by a network device, wherein the configuration information comprises at least one trigger condition for a conditional reconfiguration; and
determining, based on a movement parameter of the UE, a trigger condition corresponding to triggering of the conditional reconfiguration.

2. The method according to claim 1, wherein determining, based on the movement parameter of the UE, the trigger condition corresponding to triggering of the conditional reconfiguration, comprises:
determining, based on whether the movement parameter of the UE fulfills a demand, the trigger condition corresponding to triggering of the conditional reconfiguration.

3. The method according to claim 2, wherein the configuration information further comprises at least one parameter for triggering corresponding to each trigger condition in the at least one trigger condition, and
wherein determining, based on whether the movement parameter of the UE fulfills the demand, the trigger condition corresponding to triggering of the conditional reconfiguration, comprises:
determining, based on whether the movement parameter of the UE fulfills the demand, a parameter for triggering to be adopted; and
determining, based on the parameter for triggering to be adopted, the trigger condition corresponding to triggering of the conditional reconfiguration.

4. The method according to claim 3, wherein the configuration information further comprises a reference parameter for triggering and a parameter adjustment value, and
wherein determining, based on whether the movement parameter of the UE fulfills the demand, the parameter for triggering to be adopted, comprises:
in the case that the movement parameter fulfills the demand, determining, based on the parameter adjustment value and the reference parameter for triggering, the parameter for triggering to be adopted; or
in the case that the movement parameter does not fulfill the demand, determining the reference parameter for triggering as the parameter for triggering to be adopted.

5. The method according to claim 2, wherein determining, based on whether the movement parameter of the UE fulfills the demand, the trigger condition corresponding to triggering of the conditional reconfiguration, comprises:
in the case that the movement parameter changes from fulfilling the demand to not fulfilling the demand during a first time period, determining that the trigger condition changes from a trigger condition corresponding to fulfilling the demand to a trigger condition corresponding to not fulfilling the demand.

6. The method according to claim 2, wherein fulfilling the demand comprises one of:
the movement parameter being greater than a threshold corresponding thereto; or
the movement parameter fulfilling an event corresponding thereto.

7. The method according to claim 6, wherein
the threshold corresponding to the movement parameter is defined in a protocol, or
the configuration information further comprises the threshold corresponding to the movement parameter.

8. The method according to claim 6, wherein
the event corresponding to the movement parameter is defined in a protocol, or
the configuration information further comprises the event corresponding to the movement parameter.

9. The method according to claim 1, wherein the movement parameter comprises at least one of a speed or an altitude.

10. A method for receiving configuration information, performed by a user equipment (UE), the method comprising:
receiving configuration information sent by a network device, wherein the configuration information comprises a first type of trigger condition for a conditional reconfiguration, and the first type of trigger condition is related to a movement parameter of the UE.

11. The method according to claim 10, further comprising:
determining, based on the movement parameter of the UE, whether the first type of trigger condition is met; and
in the case that the first type of trigger condition is met, triggering the conditional reconfiguration.

12. The method according to claim 10, wherein the configuration information further comprises a second type of trigger condition for the conditional reconfiguration, and the second type of trigger condition is related to a signal strength in a cell.

13. The method according to claim 12, further comprising:
determining, based on the movement parameter of the UE, whether a demand is fulfilled; and
in the case that the demand is fulfilled, triggering the conditional reconfiguration.

14. The method according to claim 13, wherein fulfilling the demand comprises:
any one of events in the first type of trigger condition being met, and the second type of trigger condition that corresponds to the any one of events being met.

15. The method according to claim 10, wherein the first type of trigger condition comprises at least one of following events:
the movement parameter being greater than a first threshold corresponding thereto;
the movement parameter being less than a second threshold corresponding thereto; or
a change in the movement parameter during a second time period being greater than a third threshold corresponding thereto.

16. A method for sending configuration information, performed by a network device, the method comprising:
sending configuration information to a user equipment (UE), wherein the configuration information comprises one of:
at least one trigger condition for a conditional reconfiguration, and one of a threshold corresponding to a movement parameter of the UE, or an event corresponding to the movement parameter of the UE; or
a first type of trigger condition for a conditional reconfiguration, and the first type of trigger condition is related to the movement parameter of the UE.

17-25. (canceled)

26. A user equipment (UE), comprising a processor and a memory, wherein
the memory is configured to store a computer program; and
the processor is configured to execute the computer program to cause the UE to implement the method according to claim 1.

27. A non-transitory computer-readable storage medium having instructions stored thereon, which when called and executed on a computer, cause the computer to perform the method according to claim 1.

28-29. (canceled)

30. A user equipment (UE), comprising a processor and a memory, wherein
the memory is configured to store a computer program; and
the processor is configured to execute the computer program to cause the UE to implement the method according to claim 10.

31. A network device, comprising a processor and a memory, wherein
the memory is configured to store a computer program; and
the processor is configured to execute the computer program to cause the network device to implement the method according to claim 16.
